(19) United States
(12) Patent Application Publication
(10) Pub. No.: US 2009/0092276 A1
(43) Pub. Date: Apr. 9, 2009

(54) FLEXIBLE UNIVERSAL TWEETER BACK MOUNT

(75) Inventor: Chris McSweyn, Venice, CA (US)

Correspondence Address: MCDERMOTT WILL & EMERY LLP, 2049 CENTURY PARK EAST, 38th Floor, LOS ANGELES, CA, 90067-3208, US

(73) Assignee: Scosche Industries, Inc.

(21) Appl. No.: 11/867,634

(22) Filed: Oct. 4, 2007

(51) Int. Cl. H04R 1/02

(52) U.S. Cl. 381/395

(57) ABSTRACT

A speaker mounting system that mounts a speaker to a panel that may not be entirely flat. The speaker mounting system may include an adapter having a flexible flange that is configured to be attached to the panel and that is made of flexible material that readily enables the flexible flange to flex to substantially conform to the contour of the non-flat panel. The adapter may have a compartment having an end that is attached to the flexible flange and that is configured to receive and securely hold the speaker. The compartment may have a first opening through which sound may be directed and that is substantially aligned with the opening in the flange. The compartment may have a second end opposite of the first end that has a second opening through which sound may be directed. The flange and the compartment may be configured such that, when the panel includes an opening through which sound from the speaker may be directed, the speaker may be oriented within the compartment facing the panel such that the sound it makes is directed through the first opening in the compartment, the opening in the flange, and the opening in the panel; and such that, when a first panel is behind an opening in a second panel through which sound from the speaker should be directed, the speaker may be oriented within the compartment facing away from the first panel such that the sound it makes is directed thorough the second opening in the compartment and the opening in the second panel. The speaker mounting adapter may be back mounted to the panel such that no portion of the adapter lies within the opening in the panel.

### BACKGROUND

1. Field

This application relates to mounting audio speakers to panels, including tweeters in vehicles.

2. Description of Related Art

Audio speakers often need to be added to an existing installation. For example, tweeters are often installed in a vehicle after it is purchased.

To accomplish this, the speaker may need to be back mounted to the back side of an existing speaker grille. Oftentimes, the speaker will be attached to the grill using an adhesive, such as glue or double-sided adhesive tape. Unfortunately, the adhesive will sometimes fail due to heat, vibration, and/or aging, causing the speaker to detach. Detachment can be particularly frequent when the grille and/or front surface of the speaker is not entirely flat. When glue is used, moreover, the glue can spill onto a vibrating portion of the speaker, such as its diaphragm, and interfere with its operation.

Speakers are sometimes instead back mounted to a panel that is behind the grille, such as to a door sail behind a grille in a mirror cover. Glue or double-sided adhesive tape may again be used to secure the rear of the speaker to the panel. Again, however, the speaker can detach from the panel due to heat, vibration, and/or age. And again, detachment can be particularly frequent when the panel or rear of the speaker is not entirely flat.

Metal straps have instead been used to attach a speaker to a panel behind a grille. However, this approach can be labor intensive and is generally not suitable for mounting the speaker directly to the back side of a grille.

A still further approach has been to cut a hole in the panel in which the speaker is to be mounted, to insert a flush-mounted cup through the front of the hole, to lock the flush-mounted cup to the panel from behind the panel, and to insert the speaker in the cup. This approach, however, is also often labor intensive, is usually not adaptable to panels that already have a grille, and usually leaves a rim protruding from the surface of the panel.

### SUMMARY

A speaker mounting system may mount a speaker to a panel that may not be not entirely flat. The speaker mounting system may include an adapter having a flexible flange that is configured to be attached to the panel and that is made of flexible material that readily enables the flexible flange to flex to substantially conform to the contour of the non-flat panel. The adapter may have a compartment having an end that is attached to the flexible flange and that is configured to receive and securely hold the speaker.

The flange may have an opening through which sound may be directed. The compartment may have a first opening through which sound may be directed and that is substantially aligned with the opening in the flange. The compartment may have a second end opposite of the first end that has a second opening through which sound may be directed.

The flange and the compartment may be configured such that, when the panel includes an opening through which sound from the speaker may be directed, the speaker may be oriented within the compartment facing the panel such that the sound it makes is directed through the first opening in the compartment, the opening in the flange, and the opening in the panel; and such that, when a first panel is behind an opening in a second panel through which sound from the speaker should be directed, the speaker may be oriented within the compartment facing away from the first panel such that the sound it makes is directed thorough the second opening in the compartment and the opening in the second panel.

The speaker mounting adapter may be back mounted to the panel such that no portion of the adapter lies within the opening in the panel.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

FIG. 1 illustrates a speaker back mounted to a panel that is not entirely flat.

FIGS. 2(a) and 2(b) illustrate the speaker in FIG. 1 being back mounted to the non-flat panel in FIG. 1 using a speaker mounting system having an adapter with a flexible flange.

FIGS. 3(a) and 3(b) illustrate an exploded and assembled view, respectively, of the speaker mounting system in FIGS. 2(a) and 2(b).

FIG. 4 illustrates the speaker mounting assembly in FIG. 3(b) being back mounted to a curved speaker panel that is then attached to a vehicle door sail.

FIG. 5 illustrates the speaker mounting assembly in FIG. 3(b) being back mounted to a curved speaker panel that is then attached to a vehicle pillar.

FIG. 6 illustrates the speaker mounting assembly in FIG. 3(b) being backed mounted to a speaker panel that is then attached to a vehicle door.

FIGS. 7(a) and 7(b) illustrate an exploded and assembled view, respectively, of the speaker mounting system in FIG. 2(a), but with a different speaker orientation.

FIG. 8 illustrates the speaker mounting assembly in FIG. 7(b) back mounted to a panel in a vehicle door sail that is behind a speaker panel.

FIG. 9 illustrates the adapter shown in FIG. 2(a) attached to a panel with glue protruding through its holes.

FIGS. 10(a) and 10(b) illustrate the speaker in FIG. 1 back mounted to the non-flat panel in FIG. 1 using an adapter that had a portion of its flange removed.

The drawings disclose illustrative embodiments. They do not set forth all embodiments. Other embodiments may be used in addition or instead. Details that may be apparent or unnecessary may be omitted to save space or for more effective illustration. When the same numeral appears in different drawings, it is intended to refer to the same or like components or steps.

### DETAILED DESCRIPTION OF ILLUSTRATIVE EMBODIMENTS

Illustrative embodiments are now discussed. Other embodiments may be used in addition or instead. Details that may be apparent or unnecessary may be omitted to save space or for a more effective presentation.

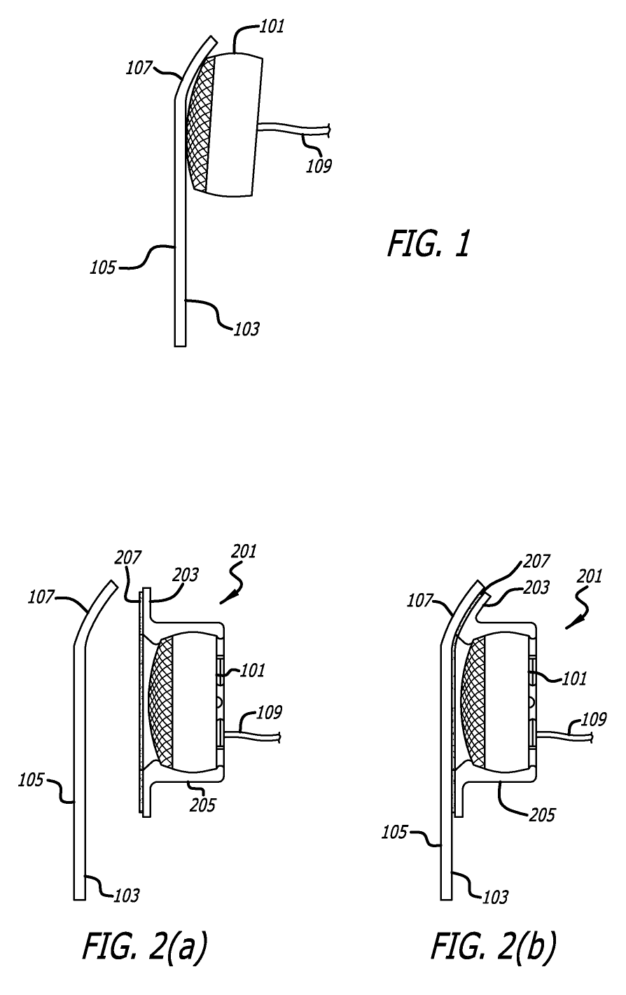

FIG. 1 illustrates a speaker back mounted to a panel that is not entirely flat. As illustrated in FIG. 1, a speaker 101 may be connected to an electrical wire 109 and may be mounted to a rear surface 103 of a panel 105. The panel may be or may include a grille through which sound may readily pass, such as a wire or cloth mesh.

The panel 105 may not be entirely flat. For example, it may have a curved portion 107.

Means such as glue or double-sided adhesive tape may be used to attached the speaker 101 to the panel 105. However, because of the curved portion 107 in the panel 105, the glue or adhesive tape may only stick to a very small area of the panel 105 and/or the speaker 101. This may place significant stress on these areas, rendering the speaker 101 susceptible to detachment, particularly when there is vibration, heat, and/or aging of the adhesive.

FIGS. 2(a) and 2(b) illustrate the speaker in FIG. 1 being back mounted to the non-flat panel in FIG. 1 using a speaker mounting system having an adaptor with a flexible flange. As shown in FIGS. 2(a) and 2(b), an adaptor 201 may include a flexible flange 203 that is configured to be attached to the rear surface 103 of the panel 105. The flange 203 may be made of flexible material that readily enables the flange 203 to substantially conform to the contour of the curved portion 107 of the panel 105.

The flexible flange 203 may be attached to the rear surface 103 of the panel 105 using any means, such as by using an adhesive, such as double-sided adhesive tape 207, glue, fasteners, and/or other means.

The adaptor 201 may include a compartment 205 having an end that is attached to the flexible flange 203. The compartment 205 may be configured to receive and securely hold the speaker 101.

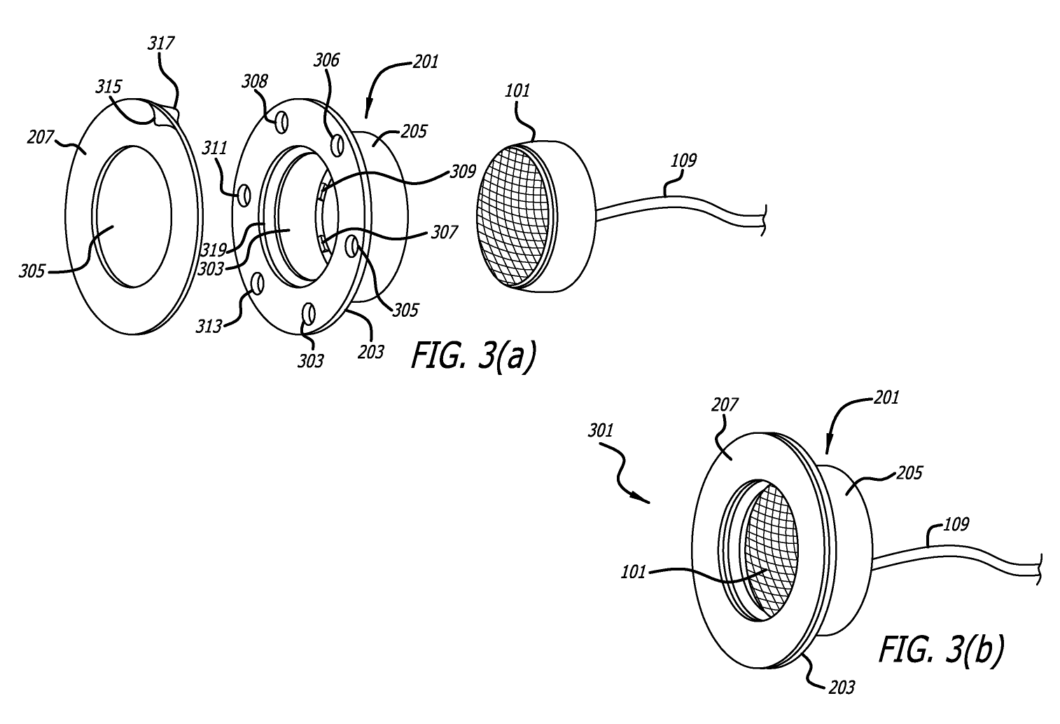

FIGS. 3(a) and 3(b) illustrate, respectively, an exploded and assembled view of the speaker mounting system in FIG. 2. As illustrated in FIGS. 3(a) and 3(b), the speaker 101, the adapter 201, and the double-sided adhesive tape 207 may be combined to form a speaker mounting assembly 301.

The speaker 101 may be of any type or size. For example, the speaker 101 may be a tweeter that is substantially cylindrical. It may instead be rectangular, oval, or any other shape. The front of the speaker 101 may be flat, curved, or may have any other contour. The front of the speaker 101 may be protected by a grille, as illustrated in FIGS. 2(a) and 2(b).

The flexible flange 203 may be in the shape of an annular ring and may have one or more openings there through, such as openings 303, 305, 306, 308, 311, and 313. The flexible flange 203 may be made of a material that readily enables the flange to flex to substantially conform to the contour of a non-flat panel to which it may be attached. For example, the flexible flange 203 may be made of flexible rubber, flexible PVC, or any other type of flexible material. In a different embodiment, the flange 203 may be made of a material that is not flexible, such as metal or plastic.

The annular shape of the flexible flange 203 may define an internal opening 303. The opening may be larger than, equal to, or smaller than the diameter of the speaker 101.

The compartment 205 may have an end that is attached to the flexible flange 203. The attachment may be effectuated with an adhesive or by virtue of the compartment 205 and the flexible flange 203 constituting a single, integral component.

The compartment 205 may be cylindrical and may have inner dimensions sized to frictionally engage the wall of the speaker 101. For example, an outer wall of the speaker 101 may be curved and the inner wall of the compartment 205 may be correspondingly curved. The compartment 205 may be of any other shape. For example, it may be oval or rectangular. The shape of the interior of the compartment 205 may or may not coincide with the shape of the exterior of the speaker 101.

The compartment 205 may have two openings. One opening may be at one end of the compartment and align with the opening 303 in the flexible flange 203. The other opening may be at the other end of the compartment 205. One or both of these openings may be sized so as to allow the speaker 101 to be inserted through the opening. Alternatively, one opening in the compartment 205 may be smaller, so that the speaker 101 may only be inserted through the other opening.

The compartment 205 may be long enough to completely cover the depth of the speaker 101, as illustrated in FIGS. 2(a) and 2(b). Alternatively, the length of the compartment 205 may be shorter than the depth of the speaker 101, thereby preventing a portion of the speaker 101 from being covered by the compartment 205, even when the speaker 101 is fully inserted in the compartment 205.

The double-sided adhesive tape 207 may be shaped so as to have a surface that has the substantially the same shape as the surface of the flexible flange 203. The double-sided adhesive tape 207 may be annular and may include an interior opening 305 through which sound from the speaker 101 may be directed. The size of the opening 305 in the double-sided adhesive tape 207 may be the same as, less than, or greater than the size of the opening 303 in the flexible flange 203. Each surface of the double-sided adhesive tape 207 may initially be protected by a non-adhering protective layer 315 and 317, such as wax paper, each of which may be pealed from the tape 207 before the surface of the tape 207 that is protected by the paper is attached.

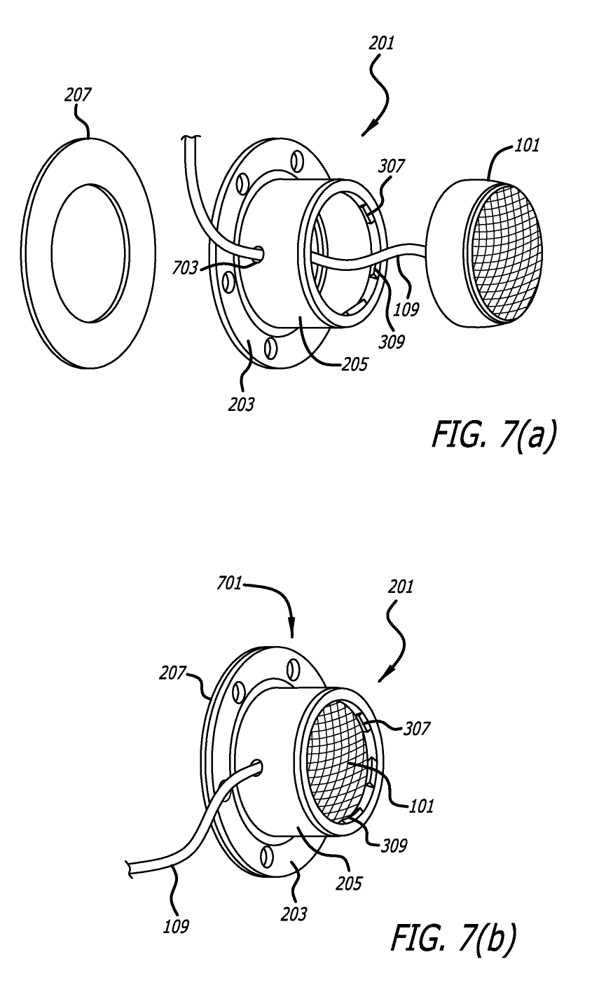

The compartment 205 that forms a part of the adaptor 201 may include a locking mechanism that locks the speaker 101 in the compartment 205 after it is inserted. The locking mechanism may include one or more tabs, such as tabs 307, 309, and other tabs not visible in FIG. 3(a), projecting inwardly from one of the openings in the compartment 205. (The tabs can more clearly be seen in FIGS. 7(a) and 7(b).) The locking mechanism may further include an interior ring 319 at the interior of the flexible flange 203 and/or the interior of the other end of the compartment 205. The diameter of the interior ring 319 may be large enough to allow all or virtually all of the sound from the speaker 101 to pass through, but small enough to prevent the speaker 101 from sliding through the interior ring 319. Although illustrated and discussed as a separate ring, the interior ring 319 may be an integral part of the flexible flange 203 and/or the compartment 205.

The interior ring 319 may have a thickness and be at a location that prevents the front of the speaker 101 from reaching the front of the flexible flange 203. This may help insure that the front of the speaker 101 does not come in contact with the grille or other panel structure to which the flange 203 may be attached, thereby minimizing distortion that might otherwise be caused.

One or more of the tabs, such as the tabs 307 and 309, may be distributed around the inner perimeter of the compartment 205. They may extend inwardly by an amount that prevents the speaker 101 from easily being removed from the compartment 205 once inserted, but not by so much as to make it difficult to insert the speaker 101 into the compartment 205. The tabs may be made of flexible material so as to facilitate the insertion of the speaker 101 into the compartment 205. The tabs may be affixed to the compartment 205, such as by being integral with the compartment 205.

The tabs and the interior ring 319 may be separated by a distance that is approximately equal to the thickness of the speaker 101, thus insuring that the speaker 101 will be securely locked within the compartment 205 after it is inserted.

The tabs and the interior ring 319 may be reversed with respect to the openings in the adaptor 201, such that the tabs are at the juncture of the compartment 205 and the flange 203, and the interior ring 319 is at the other end of the compartment 205.

Although the tabs and the interior ring 319 are illustrated as providing a locking function, any other type of locking mechanism may be used in addition or instead. For example, the outside of the speaker 101 may have a curved shape and the interior of the compartment 205 may have a matching curved shape, as illustrated in FIGS. 2(a) and 2(b).

FIG. 3(b) illustrates the components of the speaker mounting assembly 301 after having been assembled. As illustrated in FIG. 3(b), the speaker 101 has been inserted within the compartment 205 of the adaptor 201, and the double-sided adhesive tape 207 has been affixed to the surface of the flexible flange 203. As also illustrated in FIG. 3(b), the front of the speaker 101 is recessed from the front of the assembly 301, thereby insuring that the front of the speaker 101 will not come in contact with the grille or other panel to which the assembly is attached. This may prevent distortion that might otherwise be caused. This recessed position is also illustrated in FIG. 2(b).

FIG. 3(b) illustrates a configuration in which the speaker 101 has been oriented within the compartment 205 so as to direct its sound through the opening 303 in the flexible flange 203 and the opening 305 in the double-sided adhesive tape 207.

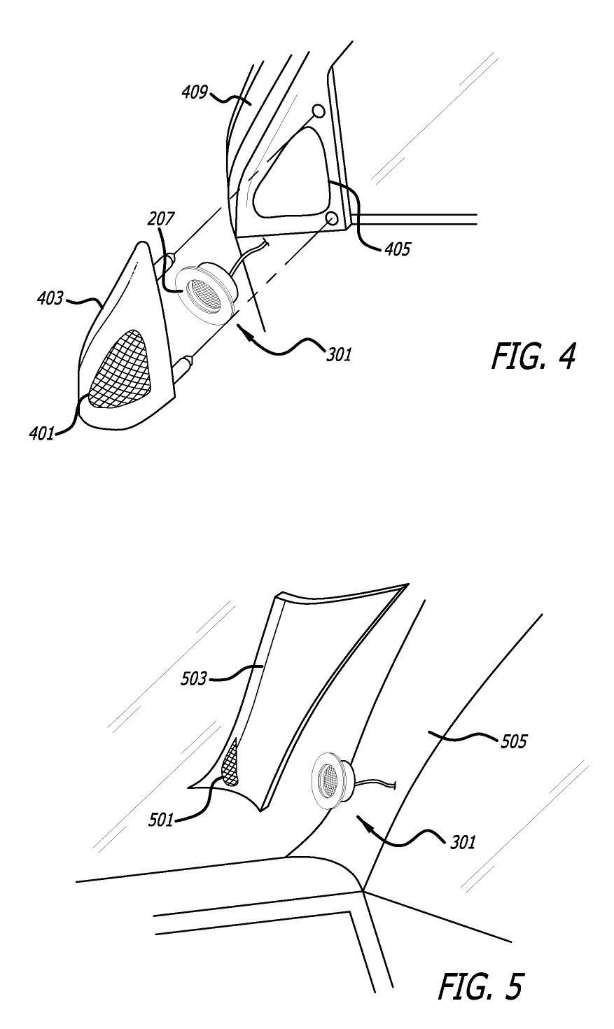

FIG. 4 illustrates the speaker mounting assembly in FIG. 3(b) being back mounted to a curved speaker panel in a vehicle door sail. As illustrated in FIG. 4, the speaker mounting assembly 301 with the adhesive surface of the double-sided adhesive tape 207 exposed may be pressed against the back side of a curved grille 401 that is part of a mirror covered triangle 403. Thereafter, the mirror covered triangle 403 with the attached speaker mounting assembly 301 may be attached to a door sail 405 of a door 407 of a vehicle.

FIG. 5 illustrates the speaker mounting assembly in FIG. 3(b) being back mounted to a curved speaker panel over a vehicle pillar. As illustrated in FIG. 5, the speaker mounting assembly 301 with the adhesive surface of the double-sided adhesive tape 207 exposed may be pressed against the back side a curved grille 501 in a trim panel 503. Thereafter, the trim panel may be attached to a pillar 505 of a vehicle.

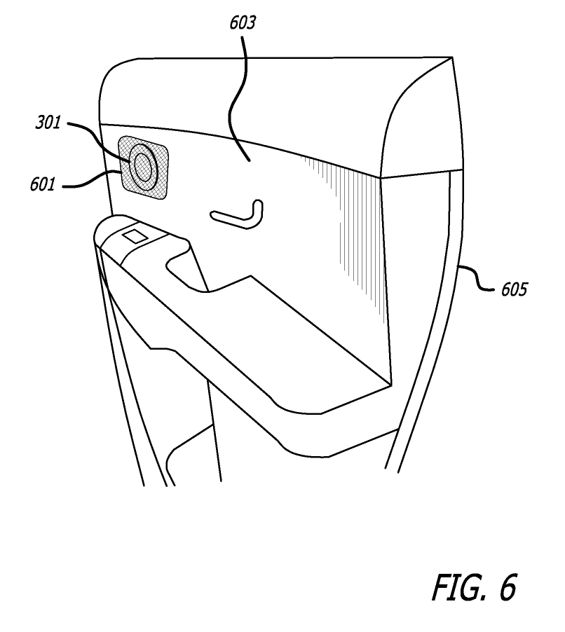

FIG. 6 illustrates the speaker mounting assembly in FIG. 3(b) being back mounted to a speaker panel in a vehicle door. As illustrated in FIG. 6, the speaker mounting assembly 301 with the adhesive surface of the double-sided adhesive tape 207 has been pressed against the back side of a grille 601 in a door panel 603 of a door 605. To facilitate this attachment, the door panel 603 may be removed from the door 605 prior to attaching the speaker mounting assembly 301.

FIGS. 7(a) and 7(b) illustrate an exploded and assembled view, respectively, of the speaker mounting system in FIG. 2(a), but with a different speaker orientation. As illustrated in FIGS. 7(a) and 7(b), the speaker 101 may be inserted within the compartment 205, much like it was in FIG. 3(a), except that the speaker may be oriented such that it directs sound through the opposite opening in the compartment 205, rather than through the opening 305 in the annular ring of the double-sided adhesive tape 207. This orientation may be useful in situations in which the speaker is mounted to a panel that is behind another panel through which the sound of the speaker is to be directed. In this embodiment, the compartment 205 may include a wire port 703 through the wall of the compartment 205 near the flexible flange 203 through which the wire 109 to the speaker 101 may be routed.

The components illustrated in FIG. 7(a) may be identical to the components illustrated in FIG. 3(a). The only difference may be the orientation of the speaker 101 during assembly. In other words, a single set of components, namely the speaker 101, the adaptor 201, and the double-sided adhesive tape 207, may be used to mount the speaker 101 either to the rear of a grille or to a panel that is behind the grille. This may enable a single set of components to be sold and used to effectuate two very different installation configurations.

FIG. 7(b) illustrates the components in FIG. 7(a) after they have been assembled into a speaker mounting assembly 701. As illustrated in FIG. 7(b), the speaker 101 has been inserted into the compartment 205 until it is locked in place. The wire 109 from the speaker 101 has been routed through the wire port 703. The double-sided adhesive tape 207 has been attached to the surface of the flexible flange 203. The configuration may be identical to the configuration illustrated in FIG. 3(b), except that the speaker may be facing the opposite direction.

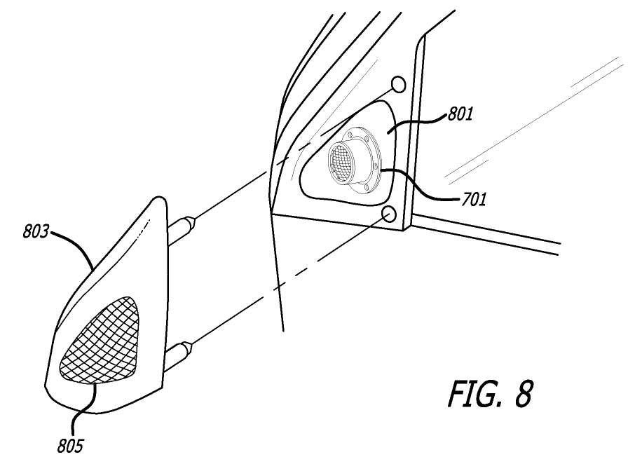

FIG. 8 illustrates the speaker mounting assembly in FIG. 7(b) back mounted to a panel in a vehicle door sail that is behind a speaker panel. As illustrated in FIG. 8, an adhesive side of the double-sided adhesive tape 207 of the speaker mounting assembly 701 has been attached to a door sail 801. Thereafter, a mirror cover triangle 803 having a grille 805 may be attached to the door sail 801.

As previously indicated, attachment means other than double-sided adhesive tape may be used to attach the flexible flange 203 to a panel, such as a grille. For example, glue may be used.

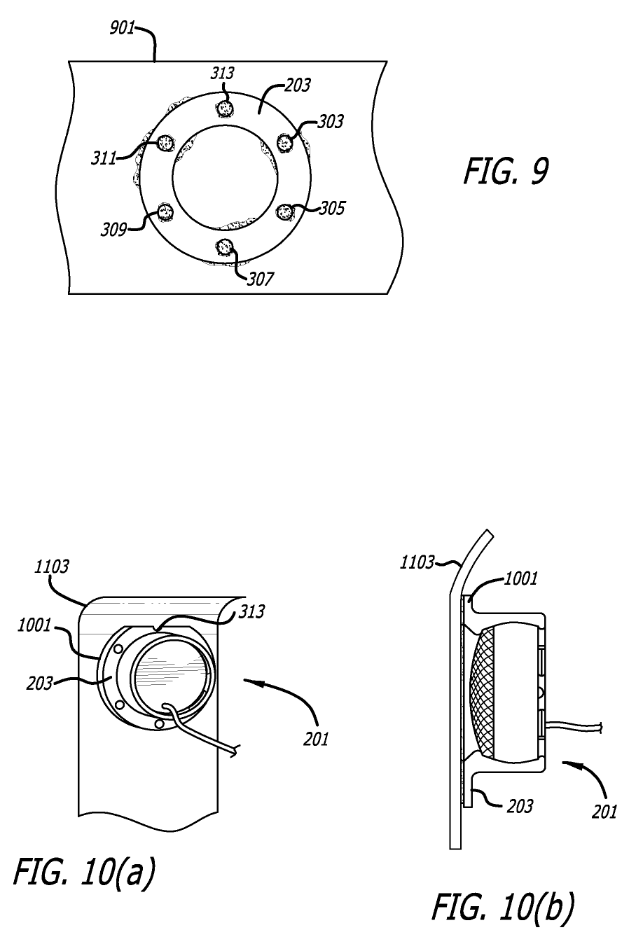

FIG. 9 illustrates the adaptor shown in FIG. 2(a) attached to a panel with glue protruding through its holes. As illustrated in FIG. 9, the adaptor 201 has been glued to a panel 901. Sufficient glue has been used such that portions of the glue have squeezed through the openings 303, 305, 306, 308, 311, and 313. When it hardens, the glue in openings may increase the adhesive strength of the glue.

FIGS. 10(a) and 10(b) illustrate the speaker in FIG. 1 back mounted to the non-flat panel in FIG. 1 using an adaptor that had a portion of its flange removed. As illustrated in FIGS. 10(a) and 10(b), a portion of the flange 203 has been cut off from the adapter 201 in FIG. 2(a), such as with a scissors, leaving an edge 1001. The flange has then been attached to a panel 1003 that begins to curve at the location of the edge 1001. This enables the flange 203 to be mounted substantially flush against the panel 1003, notwithstanding the curve in the panel and notwithstanding the possibility that the flange 203 might not be flexible. One of the openings 313 in the flange 203 may be used as a guide for making the cut in the flange with the scissors, as illustrated in FIG. 13(a).

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

For example, the speaker has thus-far been illustrated as having been inserted into the compartment of the adaptor before the adaptor has been attached to a panel. In some applications, however, the adaptor may be attached to the panel first and the speaker may thereafter be inserted.

The phrase “means for” when used in a claim embraces the corresponding structures and materials that have been described and their equivalents. Similarly, the phrase “step for” when used in a claim embraces the corresponding acts that have been described and their equivalents. The absence of these phrases means that the claim is not limited to any of the corresponding structures, materials, or acts or to their equivalents.

Nothing that has been stated or illustrated is intended to cause a dedication of any component, step, feature, object, benefit, advantage, or equivalent to the public, regardless of whether it is recited in the claims.

In short, the scope of protection is limited solely by the claims that now follow. That scope is intended to be as broad as is reasonably consistent with the language that is used in the claims and to encompass all structural and functional equivalents.

We claim:

1. A speaker mounting system for mounting a speaker to a panel that may not be entirely flat comprising an adapter having:
a flexible flange that is configured to be attached to the panel and that is made of flexible material that readily enables the flexible flange to flex to substantially conform to the contour of the non-flat panel; and
a compartment having an end that is attached to the flexible flange and that is configured to receive and securely hold the speaker.

2. The speaker mounting system of claim 1 wherein the compartment includes a locking mechanism configured to lock the speaker within the compartment.

3. The speaker mounting system of claim 2 wherein the locking mechanism include one or more tabs that protrude inwardly from the compartment.

4. The speaker mounting system of claim 2 wherein the flexible flange has a front surface configured to be attached to the panel and wherein the compartment is configured to cause the speaker, when locked within the compartment and facing the front surface of the flange, to be recessed from the front surface of the flange so as not to touch the panel during operation.

5. The speaker mounting system of claim 1 wherein the flange is made of flexible rubber.

6. The speaker mounting system of claim 1 wherein the flange is made flexible PVC.

7. The speaker mounting system of claim 1 wherein the flange and compartment constitute a single, integral component.

8. The speaker mounting system of claim 1 wherein the flange is an annular ring.

9. The speaker mounting system of claim 1 further comprising an attachment mechanism configured to attach the flexible flange to the panel.

10. The speaker mounting system of claim 9 wherein the attachment mechanism is double-sided adhesive tape.

11. The speaker mounting system of claim 9 wherein the attachment mechanism is glue.

12. The speaker mounting system of claim 11 wherein the flange has a plurality of holes there through and wherein the glue protrudes through the holes.

13. A speaker mounting system for mounting a speaker to a panel comprising an adapter having:
a flange that has an opening through which sound may be directed and that is configured to be attached to the panel; and
a compartment that is configured to receive and securely hold the speaker that has:
a first end that is attached to the flange and that has a first opening through which sound may be directed and that is substantially aligned with the opening in the flange; and
a second end opposite of the first end that has a second opening through which sound may be directed,
whereby the flange and the compartment are configured such that:
when the panel includes an opening through which sound from the speaker should be directed, the speaker may be oriented within the compartment facing the panel such that the sound it makes is directed through the first opening in the compartment, the opening in the flange, and the opening in the panel; and
when the panel is a first panel behind an opening in a second panel through which sound from the speaker should be directed, the speaker may be oriented within the compartment facing away from the first panel such that the sound it makes is directed thorough the second opening in the compartment and the opening in the second panel.

14. The speaker mounting system of claim 13 wherein the flange is an annular ring.

15. The speaker mounting system of claim 13 wherein the compartment includes a locking mechanism configured to lock the speaker at a location within the compartment.

16. A speaker mounting system and panel comprising:
a panel having an opening through which sound from a speaker behind the panel may be directed; and
a speaker mounting adapter having:
a flange attached to the panel; and
a compartment having an end that is attached to the flange and that is configured to receive and securely hold the speaker,
whereby the speaker mounting adapter is back mounted to the panel such that no portion of the adapter is within the opening in the panel.

17. The speaker mounting system and panel of claim 16 wherein the compartment includes a locking mechanism configured to lock the speaker within the compartment when the speaker is fully inserted into the compartment.

18. The speaker mounting system and panel of claim 17 wherein the flange has a front surface configured to be attached to the panel and wherein the compartment is configured to cause the speaker, when locked within the compartment, to be recessed from the panel.

19. The speaker mounting system and panel of claim 16 wherein the flange is an annular ring.

20. The speaker mounting system and panel of claim 19 wherein the panel has a portion that is not flat and wherein the annular ring has a portion that was cut off so as to allow the annular ring to attached to the panel without pressing against the portion of the panel that is not flat.

21. The speaker mounting system and panel of claim 19 wherein the portion of the annular ring that was cut off had a hole through the annular ring through which the cut was made.

22. A speaker mounting system and panel comprising:
a panel located behind an opening through which sound from a speaker behind the opening may be directed; and
a speaker mounting adapter having:
a flange attached to the panel; and
a compartment having an end that is attached to the flange and that is configured to receive and securely hold the speaker.

23. The speaker mounting system and panel of claim 22 wherein the compartment includes a wire port through which a wire to the speaker may be routed.

24. The speaker mounting system and panel of claim 22 wherein the wire port is near the flange.

25. The speaker mounting system and panel of claim 22 wherein the flange is an annular ring.
